(19) United States
(12) Patent Application Publication
(10) Pub. No.: US 2009/0176118 A1
(43) Pub. Date: Jul. 9, 2009

(54) Method for manufacturing aluminum salt solution, aluminum salt solution, aluminum salt, water purifying apparatus using the same, and articles manufactured by using the same

(75) Inventor: Isao Ishikawa, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 11/630,839

(22) PCT Filed: Jul. 4, 2005
(86) PCT No.: PCT/JP2005/012707

§ 371 Date: Dec. 22, 2006

Related U.S. Application Data
(60) Provisional application No. 60/672,872, filed on Apr. 20, 2005.

(30) Foreign Application Priority Data
Jul. 5, 2004 (JP) 2004-197736

(51) Int. Cl. C09K 3/00; B01J 14/00; C14C 9/00

(52) U.S. Cl. 428/540; 252/182.35; 252/182.34; 252/182.11; 210/198.1; 8/115.51

(57) ABSTRACT

A method for manufacturing an aluminum salt solution includes manufacturing an aluminum salt solution by using, as a raw material, an aluminum hydroxide having T-C (total carbon amount) of 0.04 mass % or less and T-Na₂O (total Na₂O amount) of less than 0.3 mass %, which is obtained by a Bayer process.

### TECHNICAL FIELD

The present invention relates to a method for manufacturing an aluminum salt solution reduced in coloration, aluminum salt solution, aluminum salt, water purifying apparatus using the same, and articles manufactured by using the same. More specifically, the present invention relates to a method for manufacturing an aluminum sulfate solution or a poly-aluminum chloride solution in which the coloration or black scum can be reduced.

The present application claims priority on Japanese Patent Application No. 2004-197736, filed on Jul. 5, 2004, and on U.S. Provisional Patent Application No. 60/672,872 filed on Apr. 20, 2005, the contents of which are incorporated herein by reference.

### BACKGROUND ART

Aluminum sulfate solution (sulfate band) and Poly-aluminum chloride solution are widely used for sizing of paper in the papermaking industry, a coagulant in the equipment for treating water and sewage, a mordant, a fire extinguisher, a raw material of various aluminum compounds, tanning of white leather, a clarifying agent of oils and fats, and various catalyst raw materials.

These aluminum sulfate solution and poly-aluminum chloride solution are manufactured by dissolving an aluminum hydroxide as a raw material with sulfuric acid or hydrochloric acid under heat, but at this time, a black scum is disadvantageously generated. The aluminum hydroxide is usually manufactured by a Bayer process and includes a humate which gives rise to the scum or coloration. This humate is removed by using a cationic polymer quaternary ammonium salt (see, Patent Document 1). In a process of filtering and purifying the aluminum sulfate or poly-aluminum chloride, such a black scum adheres to a filter medium surface and causes reduction in a filtering speed.

Furthermore, depending on usage, the coloration of aluminum sulfate solution and poly-aluminum chloride solution becomes a problem, and a decolorizing step such as treatment with activated carbon is required.

As for a method for manufacturing an aluminum sulfate solution free from coloration, a method is known which includes a step of reacting a sulfuric acid solution deprived of hydrogen peroxide with an alumina-containing substance (see, Patent Document 2). Also, a method is known which includes a step of reacting a sulfuric acid solution containing hydrogen peroxide with a hydrated alumina containing a titanium compound (see, Patent Document 3).

(Patent Document 1) Japanese published unexamined patent application S61-174113
(Patent Document 2) Japanese published unexamined patent application H05-229818
(Patent Document 3) Japanese published unexamined patent application H05-279021

### DISCLOSURE OF THE INVENTION

An object of the present invention is to provide a process for easily manufacturing an aluminum compound solution such as aluminum sulfate solution or poly-aluminum chloride solution, by using an aluminum hydroxide of generating neither a black scum nor coloration of the aluminum sulfate solution or the poly-aluminum chloride solution.

The present invention has been accomplished based on the finding that when an aluminum hydroxide is used which has T-C and T-Na₂O each reduced to a specific amount or less by adding, for example, a quaternary ammonium salt polymer to a sodium aluminate solution containing red mud having bauxite dissolved therein, generation of black scum can be reduced in a production process of an aluminum salt solution such as aluminum sulfate solution, and an aluminum sulfate solution or the like causing no coloration can be manufactured. That is, the present invention includes the following embodiments.

(1) A method for manufacturing an aluminum salt solution includes manufacturing an aluminum salt solution by using, as a raw material, an aluminum hydroxide having T-C (total carbon amount) of 0.04 mass % or less and T-Na₂O (total Na₂O amount) of less than 0.3 mass %, which is obtained by a Bayer process.

(2) A method for manufacturing an aluminum salt solution as described in (1) above, wherein the method further includes a step of manufacturing the aluminum hydroxide by adding a quaternary ammonium salt to a slurry of sodium aluminate solution containing red mud, followed by separating the red mud from the slurry, and precipitating and separating an aluminum hydroxide.

(3) A method for manufacturing an aluminum salt solution as described in (2) above, wherein an amount of the quaternary ammonium salt added is 5 mg/liter (in terms of pure content) or more, based on the slurry of sodium aluminate solution containing the red mud.

(4) A method for manufacturing an aluminum salt solution as described in (2) above, wherein the Na concentration in the slurry of sodium aluminate solution containing the red mud after adding the quaternary ammonium salt is from 100 to 250 g/liter (in terms of NaOH).

(5) A method for manufacturing an aluminum salt solution as described in (2) above, wherein in the step of manufacturing the aluminum hydroxide, an aluminum hydroxide seed slurry is added to a sodium aluminate solution from which the red mud is removed, thereby precipitating the aluminum hydroxide.

(6) A method for manufacturing an aluminum salt solution as described in (1) above, wherein the average secondary particle diameter of the aluminum hydroxide is from 1 to 150 μm.

(7) A method for manufacturing an aluminum salt solution as described in (1) above, wherein the average primary particle size of the aluminum hydroxide is from 0.5 to 70 μm, and an aggregation degree represented by a ratio (D₂/D₁) of the average secondary particle diameter D₂ to the average primary particle diameter D₁ of the aluminum hydroxide is from 10 to 40.

(8) A method for manufacturing an aluminum salt solution as described in (1) above, wherein the aluminum salt is aluminum sulfate or poly-aluminum chloride.

(9) A method for manufacturing an aluminum salt solution as described in (8), wherein the aluminum hydroxide is dissolved under heat in sulfuric acid or hydrochloric acid, thereby the aluminum salt solution is obtained.

(10) An aluminum salt solution which is manufactured by a method for manufacturing an aluminum salt solution described in (1) above.

(11) An aluminum salt solution as described in (10) above, wherein the aluminum salt is aluminum sulfate or poly-aluminum chloride.

(12) An aluminum salt which is obtained from an aluminum salt solution described in (10) above.

(13) A water purifying apparatus includes: a mixing tank in which an aluminum salt solution described in (11) above is added to wastewater to obtain a mixed solution; and a precipitation tank in which aggregates are precipitated from the mixed solution.

(14) An article which is manufactured by using an aluminum salt solution described in (11) above.

(15) An article as described in (14) above, which is a paper manufactured by using the aluminum salt solution.

(16) An article as described in (14) above, which is a cloth dyed by using the aluminum salt solution.

(17) An article as described in (14) above, which is an aluminum compound manufactured by using the aluminum salt solution.

(18) An article as described in (14) above, which is a white leather manufactured by using the aluminum salt solution.

(19) An article as described in (14) above, which is one of Oils and fats clarified by using the aluminum salt solution.

(20) An article as described in (14) above, which is a catalyst manufactured by using the aluminum salt solution.

According to the method for manufacturing an aluminum salt solution of the present invention, at the time of precipitating and separating an aluminum hydroxide from a sodium aluminate solution in the Bayer process, for example, a quaternary ammonium salt polymer is added to the sodium aluminate solution before the separation of red mud. By such a very simple and easy method, the T-C and T-Na₂O contained in the aluminum hydroxide are each reduced to a specific amount or less, and when this aluminum hydroxide is used as a raw material of an aluminum salt solution such as aluminum sulfate solution or poly-aluminum chloride solution, not only the generation of a black scum due to impurities such as organic material carried over from the aluminum oxide but also the coloration of the aluminum sulfate solution, poly-aluminum chloride solution, or the like are decreased. Accordingly, amount of activated carbon used for decolorization or amount of diatomaceous earth used as a filtering aid is decreased and at the same time, shortening of the filtering time and simplification of a filtering and purification step are achieved, so that improvement of equipment capacity, curtailment of production cost, and the like can be realized.

Furthermore, since the primary particle diameter and secondary particle diameter of the aluminum hydroxide particle are controlled, excellent solubility in an acid and in turn, a shortened production process of an aluminum salt solution are attained and this is very useful in industry.

### BEST MODE FOR CARRYING OUT THE INVENTION

The present invention is described in detail below.

The aluminum salt solution is described by taking aluminum sulfate solution as an example. The present invention is characterized by using a specific aluminum hydroxide as a raw material of the aluminum salt solution and therefore, the same applies to aluminum chloride solution (including poly-aluminum chloride solution) and other aluminum salt solutions.

For producing an aluminum sulfate solution reduced in coloration and free from generation of a black scum, the T-C in the aluminum hydroxide used as a raw material must be 0.04 mass % or less. The T-C is preferably 0.03 mass % or less, more preferably 0.02 mass % or less. In the case in which the T-C in the aluminum hydroxide exceeds 0.04 mass %, this tends to cause increase in the generation amount of a black scum at the production of aluminum sulfate or increase in the coloration of the aluminum sulfate solution.

In the case in which the T-Na₂O in the aluminum hydroxide is large, this tends to cause increase in the generation amount of a black scum at the production of aluminum sulfate or in the coloration of the aluminum sulfate solution. Furthermore, in the case in which Na₂O is present in a large amount in the aluminum hydroxide, when dissolving the aluminum hydroxide with concentrated sulfuric acid, sodium sulfate as an impurity is manufactured in a large amount due to a neutralization reaction with the concentrated sulfuric acid, as a result, a part of the concentrated sulfuric acid is additionally consumed by this reaction and the production efficiency changes for the worse (the consumption of concentrated sulfuric acid increases). Accordingly, the T-Na₂O in the aluminum hydroxide must be lowered, that is, the T-Na₂O is less than 0.3 mass % and is preferably 0.28 mass % or less.

The aluminum hydroxide for use in the present invention is an aluminum hydroxide obtained from a sodium aluminate solution by the Bayer process. This aluminum hydroxide is obtained by adding a quaternary ammonium salt to a sodium aluminate solution containing red mud to decrease T-C and the like contained in the sodium aluminate solution and decrease the impurities such as T-C and T-Na₂O adhering to the precipitated aluminum hydroxide. A substance other than a quaternary ammonium salt may also be used as long as T-C and T-Na₂O can be similarly decreased.

When this aluminum hydroxide is used as a raw material of an aluminum sulfate, the generation amount of a black scum in the process of producing an aluminum sulfate as well as the coloration of an aluminum sulfate solution can be decreased.

When the generation amount of a black scum in the aluminum sulfate solution as well as the coloration of aluminum sulfate are decreased, this gives an effect of enhancing the productivity and decreasing the cost in the production of the product.

The sodium aluminate solution for use in the present invention is not particularly limited in the alkali concentration, alumina concentration, or the like as long as an aluminum hydroxide can be obtained by the precipitation method. A sodium aluminate solution having an NaOH concentration of 100 to 250 g/liter and an Al₂O₃/NaOH concentration ratio (by weight) of approximately from 0.5 to 0.9 is preferably used.

The quaternary ammonium salt for use in the present invention is preferably water-soluble, and this is a compound represented by formula 1 (wherein R is a hydrocarbon group or the like). Examples thereof include diallyl dimethyl ammonium chloride (DADMAC (registered trademark)) (formula (2) and polymers containing DADMAC, such as polydiallyl dimethyl ammonium chloride (POLYDADOMAC) compound. Among these, polymers are preferred.

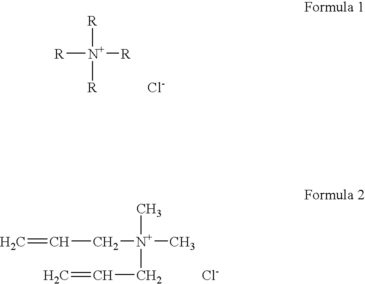

As for the monomer diallyl dimethyl ammonium chloride (DADMAC), those manufactured by adding allyl chloride to dimethylamine can be used.

In practicing the present invention, the amount of the quaternary ammonium salt added to the sodium aluminate solution containing red mud having bauxite dissolved therein is preferably such an amount as to enable uniform dispersion in the sodium aluminate solution and this is, in terms of the pure content, preferably 5 mg/liter or more, more preferably from 10 to 500 mg/liter, and most preferably from 20 to 100 mg/liter.

In the case in which the amount added is less than 5 mg/liter, the performance of causing the organic material in the sodium aluminate solution to adsorb to the red mud side is poor and the removal effect is not satisfied, whereas if the amount added exceeds 500 mg/liter, an excessive additive comes to be present in the purified sodium aluminate solution, though the effect of removing the impurity organic material in the sodium aluminate solution is promoted.

The method for adding the quaternary ammonium salt to the sodium aluminate solution is not particularly limited, but the quaternary ammonium salt is preferably added as an aqueous solution, to the sodium aluminate solution containing the red mud while stirring.

The average secondary particle diameter of the aluminum hydroxide is preferably from 1 to 150 μm, more preferably from 30 to 80 μm, still more preferably from 40 to 60 μm. In the case in which the average secondary particle diameter of the aluminum hydroxide is less than 1 μm, the reactivity at the dissolution with sulfuric acid may vigorously bump. In the case in which it exceeds 150 μm, an undissolved residue may increase at the dissolution with sulfuric acid. Even if the average secondary particle diameter is the same, the solubility of aluminum hydroxide particles in a concentrated sulfuric acid varies depending on the difference in the primary particle size and the aggregation degree. When compared between the secondary particle in which primary particles having a large particle diameter aggregate and the secondary particle in which primary particles having a small particle diameter aggregate, the solubility tends to be higher in the latter. The particle surface area is larger in the case in which fine primary particles are aggregated, and the concentrated sulfuric acid as a solvent intrudes into the void among primary particles, whereby the solubility is enhanced. The average primary particle diameter is preferably from 0.5 to 70 μm, more preferably from 1 to 20 μm, still more preferably from 2 to 10 μm. In the case in which the average primary particle diameter is larger than this range, the dissolution in an acid may take time. Whereas in the case in which it is less than this range, the reactivity at the dissolution with sulfuric acid may vigorously bump. Furthermore, this tends to cause increase in the content of sodium taken into the primary particle constituting the secondary particle. Considering the workability at the dissolution with sulfuric acid as well as the solubility in sulfuric acid and characteristic properties of aluminum hydroxide, a sodium hydroxide which is an aggregate of relatively fine particles is preferred. That is, it is preferred that the above-described average secondary particle diameter and average primary particle diameter are satisfied, and the aggregation degree represented by the ratio (D₂/D₁) of the average secondary particle diameter D₂ to the average primary particle diameter D₁ is from 10 to 40, more preferably from 15 to 30. The average secondary particle diameter D₂ is an average particle diameter measured by a particle size analyzer such as Microtrac, and the average primary particle diameter D₁ is calculated based on the BET specific surface area measured by means of a specific surface area measuring apparatus according to D₁=6/(BET specific surface area×true specific gravity) by approximation of the particle to a sphere.

The aluminum hydroxide particle can be obtained, for example, by the following method. A quaternary ammonium salt is added to a sodium aluminate supersaturated solution containing red mud to cause organic material in the sodium aluminate solution to adsorb to the red mud, and the red mud having the organic material adsorbed thereto is removed from the sodium aluminate solution. An aluminum hydroxide seed slurry containing fine particles is added to this sodium aluminate solution (in the supersaturated state), and aluminum hydroxide is precipitated at a relatively low temperature (55 to 60° C.). A part of the alumina portion in the supersaturated solution is precipitated as a fine particle nucleus in the liquid and aggregates on the surface of the added seed. Also, another part of the alumina portion in the solution contributes to the crystal growth of aluminum hydroxide on the seed surface or the crystal growth of fine particle nucleus adhering to the seed. This state is kept for a precipitation time of 20 to 60 hours to allow for repeated particle growth and aggregation, whereby the preferred aluminum hydroxide described above is obtained.

The T-C contained in the aluminum hydroxide obtained by the production process of the present invention is measured and determined by using CARBON-ANALYZER (EMIA-820W (manufactured by Horiba Ltd.)).

The reason why an aluminum hydroxide with a small T-C is obtained by the present invention is considered as follows. When the sodium aluminate solution containing red mud is treated with the quaternary ammonium salt, the organic material forms a coat or a layer on the surface of a solid (red mud), and the organic impurities (organic acids such as sodium oxalate, acetic acid, formic acid, succinic acid, maleic acid, humic acid and gluconic acid) contained in the sodium aluminate solution are removed together with the red mud from the sodium aluminate solution.

In the present invention, the sodium hydroxide concentration and the alumina concentration in the sodium aluminate solution are analyzed in the following manner. A part of a sodium aluminate solution as a sample liquid is sampled and diluted in a measuring flask (100 ml), a part thereof is sampled, a 20 wt % sodium gluconate solution is added thereto to complex alumina in the sample liquid, and the sample liquid is neutralized with a hydrochloric acid solution in a concentration of 0.3 mol/liter, thereby the NaOH concentration is determined. Thereafter, a 5 mass % sodium fluoride solution is added to the sample liquid to isolate a sodium hydroxide portion corresponding to the complexed alumina portion, and the isolated sodium hydroxide portion is neutralized with a hydrochloric acid solution of 0.3 mol/liter, thereby the alumina concentration is determined.

The sodium carbonate concentration in the sodium aluminate solution is determined by the Konishi method (analysis of lime, described in JIS R9011). More specifically, hydrochloric acid or sulfuric acid is added to a part of a diluted sample solution, the carbonic acid gas generated is absorbed into a dilute sodium hydroxide solution having a known concentration to partially manufacture barium carbonate, the sodium portion in difference consumed as the carbonate is determined by neutralization titration, and the sodium carbonate concentration is calculated. The concentration of free sodium hydroxide in the sodium aluminate solution is determined as a value obtained by subtracting the sodium carbonate concentration determined as above from the total sodium hydroxide concentration including sodium carbonate.

In the present invention, the sodium hydroxide concentration is preferably from 100 to 250 g/liter and the alumina concentration is preferably from 80 to 150 g/liter. In the case in which these concentrations largely exceed such ranges, the alumina hydroxide may not be stably precipitated. For producing an aluminum salt solution such as aluminum sulfate solution and aluminum chloride solution from the aluminum hydroxide, this may be attained by adding sulfuric acid, hydrochloric acid, or the like to the aluminum hydroxide and dissolving the aluminum hydroxide under heat in a usual manner.

As described in detail, according to the method of the present invention, a quaternary ammonium salt is added to a sodium aluminate solution containing red mud to reduce the organic material contained in the solution, an aluminum hydroxide is manufactured by using the resulting sodium aluminate solution reduced in the T-C and T-Na₂O. And aluminum sulfate or poly-aluminum chloride solution or the like is manufactured by using this aluminum hydroxide as a raw material, whereby a black scum generated from the raw material aluminum hydroxide is decreased, resulting in enhancement of the filtering treatment capacity, and the aluminum sulfate solution, poly-aluminum chloride solution or the like is prevented from coloration, bringing about curtailment of the activated carbon treatment cost in the decolorization step. Considering these and other effects, the present invention has a high utility value in industry.

A water purifying apparatus of the present invention includes a mixing tank in which an aluminum salt solution of the present invention is added to wastewater to obtain a mixed solution, and a precipitation tank in which aggregates are precipitated from the mixed solution. When the aluminum salt solution of the present invention is added to the wastewater, fine particles in the wastewater are adsorbed in a gel of hydrated alumina to be flocks (aggregates). Since in the aluminum salt solution of the present invention, a black scum is decreased, thereby the filtering treatment capacity is enhanced.

As described above, the method of the present invention is efficiently usable, for example, for a water purifying apparatus, sizing of paper, a mordant of cloth and the like, a raw material of various aluminum compounds, tanning of white leather, a clarifying agent of oils and fats, and a catalyst, and therefore, this is industrially useful.

### EXAMPLES

The present invention is described in greater detail below by referring to Examples, but the present invention is not limited to these Examples.

Here, the average primary particle diameter D₁, the average secondary particle diameter D₂, and T-Na₂O, of the precipitated aluminum hydroxide, and the amount of a black scum in the production process of aluminum sulfate were determined by the following methods.

### (Method for Measuring Average Primary Particle Diameter D₁ of Aluminum Hydroxide)

Using a BET specific surface area measuring apparatus Multisorb 12 (manufactured by Yuasa Ionics Inc.), an aluminum hydroxide sample was sampled in a glass cell and cooled with liquid nitrogen to cause the nitrogen gas to adsorb to the sample surface, the amount of the adsorbed gas was determined, and the BET specific surface area was calculated. The D₁ was calculated based on the obtained BET specific surface area according to D₁=6/(BET specific surface area×true specific gravity). Incidentally, the true specific gravity of the aluminum hydroxide was assumed to be 2.42.

### (Method for Measuring Average Secondary Particle Diameter D₂ of Aluminum Hydroxide)

Using Microtrac X-100 (manufactured by Nikkiso Co., Ltd.), a sample was dispersed in a solution, the intensity of light reflected and scattered from the sample of the laser diffraction ray was measured, and the average particle diameter was determined.

### (Method for Measuring T-C in Aluminum Hydroxide)

Using Carbon-Analyzer (EMIA-820W (manufactured by Horiba Ltd.)), an aluminum hydroxide sample was heated and decomposed in a high-frequency induction heating furnace, CO and CO₂ decomposed and generated from the organic compounds contained in the aluminum hydroxide were detected with an infrared detector, and the total carbon (T-C) was determined.

### (Method for Measuring T-Na₂O in Aluminum Hydroxide)

Aluminum hydroxide was dissolved under heating by adding a sulfuric acid solution of about 50 mass %, the dissolved solution was transferred to a 250 ml-volume measuring flask, 25 ml of a lithium chloride solution (0.02 mass % solution) was added as an internal standard solution, the resulting solution was diluted and made to a constant volume and then subjected to measurement of absorbance with use of a flame photometer (manufactured by Kotaki), and the T-Na₂O was determined.

### (Method for Determining Amount of Black Scum in Aluminum Sulfate)

An aluminum sulfate solution was diluted with a large amount of water, the black scum floating in the aluminum sulfate solution was filtered through a Kiriyama funnel (qualitative filter paper) and washed with water, the entire amount of the black scum remaining on the filter paper was transferred to a 200 ml-volume beaker, 50 ml of sodium hydroxide at a concentration of 0.2 mol/liter was added thereto, and the black scum was dissolved under heat in the dilute sodium hydroxide solution. At this time, the black scum entirely dissolved in the dilute sodium hydroxide and stained a vermilion color. This colored solution was transferred to a 100 ml-volume measuring flask and made to a constant volume of 100 ml with dilute sodium hydroxide at a concentration of 0.2 mol/liter, and a part thereof was sampled and subjected to measurement of absorbance at an absorption wavelength of 510 nm by a spectrophotometer UV-150-01 (manufactured by Shimadzu Corporation) using a 10-mm cell.

(Dissolution Percentage with Sulfuric Acid for 90 Minutes)

In a 1 liter-volume three-neck flask, 100 g of a sample aluminum hydroxide and 525 g of purified water were charged and kept with stirring. Subsequently, 193 g of a concentrated sulfuric acid (98%) sampled in a beaker was gradually added to the flask and after the entire amount was added, the flask was kept at 105° C., thereby dissolving aluminum hydroxide. The dissolved solution which was kept for 90 minutes after adding the concentrated sulfuric acid, and a part of the dissolved solution was sampled and filtered. A part of a filtrate was sampled and the alumina concentration was determined by neutralization titration, and the dissolution percentage was calculated.

### (Dissolution Residue)

In a 1 liter-volume three-neck flask, 193 g of a sample aluminum hydroxide and 250 g of purified water were charged and kept with stirring. Subsequently, 195 g of a concentrated sulfuric acid (98%) sampled in a beaker was gradually added to the flask and after the entire amount was added, the flask was kept at 105° C., thereby dissolving aluminum hydroxide. After passage of 1 hour, the dissolved solution was diluted and cooled by adding purified water to the flask, the resulting solution was filtered through a 10 cmφ Buechner funnel, then washed and dried and by measuring the weight of the obtained residue, the dissolution residue was determined.

### (Method for Measuring Color Tone of Aluminum Sulfate Solution)

In a 3 liter-volume flask, previously weighed aluminum hydroxide and purified water were charged and stirred with a magnet stirrer. Subsequently, a concentrated sulfuric acid solution in an amount of 1.5 times stoichiometrically equivalent to the aluminum hydroxide was gradually added, and the aluminum hydroxide was dissolved under heating by using an oil bath. Thereafter, the dissolved solution was diluted and cooled by adding a large amount of purified water and, the diluted aluminum sulfate solution was filtered through a Kiriyama funnel (qualitative filter paper), a part of the filtrate was sampled and by measuring the color difference (L, a, b) stipulated in JIS Z8792 with light transmission-type Colour-Analyzer (manufactured by Suga), the color tone was determined.

### EXAMPLES AND COMPARATIVE EXAMPLES

The present invention is described in greater detail below by referring to Examples and Comparative Examples, but the present invention is not limited to these Examples.

A sodium aluminate solution (1 liter) containing red mud having bauxite dissolved therein was kept at a slurry temperature of around 95° C. while stirring on an oil bath. To this solution, a predetermined amount of polydiallyl dimethyl ammonium chloride solution (DADMAC) (20 mass %) was added to give a concentration shown in Table 1. After 10 to 15 minutes passed, sodium polyacrylate which is a general coagulant was added to precipitate the red mud, and the supernatant sodium aluminate solution was filtered by using a suction-type Buechner funnel and a filtering bottle to obtain a clean sodium aluminate solution.

The clean sodium aluminate solution had a sodium concentration of 145 g/liter in terms of NaOH and an aluminum concentration of about 112 g/liter in terms of alumina. This sodium aluminate solution was temperature-regulated to 55° C. and after adding an aluminum hydroxide seed slurry, kept for 24 hours while stirring, thereby precipitating aluminum hydroxide. To this aluminum hydroxide, concentrated sulfuric acid nearly in a stoichiometrically equivalent amount was added to obtain aluminum sulfate solution. These aluminum hydroxide and aluminum sulfate solution are shown in Table 1.

As seen from Table 1, the raw material aluminum hydroxide of the present invention exhibits high dissolution percentage with sulfuric acid and small dissolution residue. Also, the coloration degree of the aluminum sulfate solution is low. Incidentally, in all of Examples 1 and 2 and Comparative Examples 1 to 3, troubles such as bumping owing to an abrupt reaction did not occur at the preparation of the aluminum sulfate solution.

TABLE 1

| | | Amount of | | BET Specific | | Aggregation |
|---|---|---|---|---|---|---|
| | | DADMAC added | D₁ | Surface Area | D₂ | Degree |
| | Additive | (mg/liter) | (μm) | (m²/g) | (μm) | D₂/D₁ |
| Example 1 | DADMAC | 50 | 5.0 | 0.50 | 60 | 12 |
| Example 2 | DADMAC | 200 | 5.5 | 0.45 | 60 | 11 |
| Comparative | DADMAC | 0 | 4.1 | 0.60 | 60 | 15 |
| Example 1 | | | | | | |
| Comparative | DADMAC | 5 | 4.1 | 0.60 | 60 | 15 |
| Example 2 | | | | | | |
| Comparative | DADMAC | 20 | 4.1 | 0.60 | 60 | 15 |
| Example 3 | | | | | | |

| | | | | Dissolution | | |
|---|---|---|---|---|---|---|
| | T-C Concentration | T-Na₂O Concentration | Amount of Black | Percentage with | Dissolution | Color Difference |
| | in Aluminum Hydroxide | of Aluminum Hydroxide | Scum in Aluminum | Sulfuric Acid | Residue | (L, a, b) of Aluminum |
| | (mass %) | (mass %) | Sulfate (ppm) | for 90 Minutes (%) | (mass %) | Sulfate Solution |
| Example 1 | 0.024 | 0.28 | 7 | 93 | 0.25 | (98.2, −0.2, 2.6) |
| Example 2 | 0.020 | 0.24 | 6 | 94 | 0.20 | (97.8, −0.1, 2.3) |
| Comparative | 0.036 | 0.32 | 15 | 92 | 0.35 | (97.8, −0.4, 3.9) |
| Example 1 | | | | | | |
| Comparative | 0.036 | 0.32 | 15 | 92 | 0.30 | (97.8, −0.4, 3.8) |
| Example 2 | | | | | | |
| Comparative | 0.032 | 0.30 | 10 | 92 | 0.30 | (98.0, −0.3, 3.0) |
| Example 3 | | | | | | |

### INDUSTRIAL APPLICABILITY

Aluminum salt solutions such as aluminum sulfate solution (sulfate band) and poly-aluminum chloride solution can be widely used for sizing of paper in the papermaking industry, a coagulant in the equipment for treating water and sewage, a mordant, a fire extinguisher, a raw material of various aluminum compounds, tanning of white leather, a clarifying agent of oils and fats, and various catalyst raw materials.

1. A method for manufacturing an aluminum salt solution, comprising manufacturing an aluminum salt solution by using, as a raw material, an aluminum hydroxide having T-C (total carbon amount) of 0.04 mass % or less and T-Na₂O (total Na₂O amount) of less than 0.3 mass %, which is obtained by a Bayer process.

2. A method for manufacturing an aluminum salt solution according to claim 1, wherein the method further comprises a step of manufacturing the aluminum hydroxide by adding a quaternary ammonium salt to a slurry of sodium aluminate solution containing red mud, followed by separating the red mud from the slurry, and precipitating and separating an aluminum hydroxide.

3. A method for manufacturing an aluminum salt solution according to claim 2, wherein an amount of the quaternary ammonium salt added is 5 mg/liter (in terms of pure content) or more, based on the slurry of sodium aluminate solution containing the red mud.

4. A method for manufacturing an aluminum salt solution according to claim 2, wherein the Na concentration in the slurry of sodium aluminate solution containing the red mud after adding the quaternary ammonium salt is from 100 to 250 g/liter (in terms of NaOH).

5. A method for manufacturing an aluminum salt solution according to claim 2, wherein in the step of manufacturing the aluminum hydroxide, an aluminum hydroxide seed slurry is added to a sodium aluminate solution from which the red mud is removed, thereby precipitating the aluminum hydroxide.

6. A method for manufacturing an aluminum salt solution according to claim 1, wherein the average secondary particle diameter of the aluminum hydroxide is from 1 to 150 μm.

7. A method for manufacturing an aluminum salt solution according to claim 1, wherein the average primary particle size of the aluminum hydroxide is from 0.5 to 70 μm, and an aggregation degree represented by a ratio (D₂/D₁) of the average secondary particle diameter D₂ to the average primary particle diameter D₁ of the aluminum hydroxide is from 10 to 40.

8. A method for manufacturing an aluminum salt solution according to claim 1, wherein the aluminum salt is aluminum sulfate or poly-aluminum chloride.

9. A method for manufacturing an aluminum salt solution according to claim 8, wherein the aluminum hydroxide is dissolved under heat in sulfuric acid or hydrochloric acid, thereby the aluminum salt solution is obtained.

10. An aluminum salt solution which is manufactured by a method for manufacturing an aluminum salt solution according to claim 1.

11. An aluminum salt solution according to claim 10, wherein the aluminum salt is aluminum sulfate or poly-aluminum chloride.

12. An aluminum salt which is obtained from an aluminum salt solution according to claim 10.

13. A water purifying apparatus, comprising: a mixing tank in which an aluminum salt solution according to claim 11 is added to wastewater to obtain a mixed solution; and a precipitation tank in which aggregates are precipitated from the mixed solution.

14. An article which is manufactured by using an aluminum salt solution according to claim 11.

15. An article according to claim 14 which is a paper manufactured by using the aluminum salt solution.

16. An article according to claim 14 which is a cloth dyed by using an aluminum salt solution.

17. An article according to claim 14 which is an aluminum compound manufactured by using the aluminum salt solution.

18. An article according to claim 14 which is a white leather manufactured by using the aluminum salt solution.

19. An article according to claim 14 which is one of Oils and fats clarified by using the aluminum salt solution.

20. An article according to claim 14 which is a catalyst manufactured by using the aluminum salt solution.
